(19) United States
(12) Patent Application Publication
(10) Pub. No.: US 2007/0271716 A1
(43) Pub. Date: Nov. 29, 2007

(54) Compressed Articles

(76) Inventor: Donald Spector, New York, NY (US)

Correspondence Address: DIEHL SERVILLA LLC, 77 BRANT AVE, SUITE 210, CLARK, NJ, 07066, US

(21) Appl. No.: 11/424,152

(22) Filed: Jun. 14, 2006

Related U.S. Application Data
(63) Continuation-in-part of application No. 11/439,831, filed on May 23, 2006.

(51) Int. Cl. B08B 1/00

(52) U.S. Cl. 15/104.93

(57) ABSTRACT

An article formed from compressed paper, sponge or fabric that is expandable upon contact with water includes a preselected amount of a surface active agent. The article of the invention may also include microencapsulated materials. The article of the invention may be packaged in a package that substantially maintains it in the compressed state until the package is removed. Microencapsulation permits a wide range of products to be incorporated into these compressed products while maintaining the dry, compressed nature of the products. In one aspect, methods are provided that comprise forming the article, that comprises paper, sponge or fabric, in a size of intended use; attaching a plurality of microencapsulated beads containing a material therein to the paper, sponge or fabric; and compressing the article to a compressed size that is smaller than the size of intended use. In another aspect, articles comprise a liquid-expandable paper, sponge or fabric, and a plurality of microencapsulated beads containing a material therein attached to the paper, sponge or fabric.

### RELATED APPLICATIONS

This application is a Continuation-in-Part application of U.S. patent application Ser. No. 11/439,831, filed on May 23, 2006, which is hereby incorporated by reference.

### FIELD OF INVENTION

This application relates to the field of compressed paper and woven goods.

### BACKGROUND OF THE INVENTION

Products made in a compressed state are small, for example, the size of a coin or a button. When such products are put into a liquid, for example, water, they expand, become larger, and are then suitable for their intended purpose. For example, buttons of compressed paper can be hydrated to be used as wipes. In other examples, compressed fabrics are hydrated to make towels, face cloths, tee shirts, and other clothing. Compressed sponges that expand upon contact with water are another example.

Compressed goods are useful because their light weight and small size make shipping and handling them easier than otherwise. There is a need to provide compressed goods with enhanced features, for example, ones that provide medicinal or comfort therapies.

### DESCRIPTION OF THE DRAWINGS

FIGS. 1 and 2 illustrate a compressed cloth having microencapsulated and non-encapsulated beads in accordance with various aspects of the present invention.

FIG. 3 illustrates a method in accordance with one aspect of the present invention.

### SUMMARY OF THE INVENTION

In one aspect of the invention, microencapsulated materials are added to compressed products. Generally, the materials are added to the products before the products are compressed. The microencapsulated products can also be added to the products after they have been compressed.

Microencapsulation permits a wide range of products to be incorporated into these dehydrated compressed products while maintaining the dry, compressed nature of the products. The coatings of microencapsulated beads of material can be soluble in various types of liquid, for example, water. Moreover, in some examples, it may be desirable that the coatings only release material upon mechanical force, e.g., friction.

Methods of making an article are provided, the methods comprising forming the article, that comprises paper or fabric, in a size of intended use; attaching a plurality of microencapsulated beads containing a material therein to the paper or fabric; and compressing the article to a compressed size that is smaller than the size of intended use. In one embodiment, the step of compressing the article comprises dehydrating the article. In another embodiment, the step of compressing the article comprises exposing the article to vacuum pressure. In yet another embodiment, the method further comprises contacting the article with a liquid to expand the article to approximately the size of intended use.

In another aspect of the invention, the articles comprise a liquid-expandable paper or fabric, and a plurality of microencapsulated beads containing a material therein attached to the paper or fabric. Generally, the paper or fabric material is in a compressed state and the material remains compressed until a liquid contacts the material. This application may refer to the compressed paper or cloth as a compressed coin. In some examples, the microencapsulated beads are attached to the surface of the paper or fabric. In other examples, the beads are embedded within the fabric or paper.

In one embodiment, the material is released from the beads upon expansion of the paper or fabric in the liquid. In some examples, the material comprises therapeutic compounds such as antibiotics or alcohols, to be used, for example, for cleaning wounds or other medicinal purposes. Articles having such materials can be useful in military or third world environments. In other examples, the material comprises comforting compounds such as a fragrance, an oil, a skin-moisturizer, or combinations thereof. Articles having such materials can be used as compresses for aromatherapy or other relaxation therapies.

In some embodiments, articles in accordance with the present invention comprise a towel, a face cloth, or a wiping cloth.

There are many uses for the micro encapsulated products in accordance with various aspects of the present invention. One use is combining the compressed coins with coated alcohol or antibiotic. When they are expanded, they then have the ability to be able to be used to clean wounds and other medical uses. This might be of particular value in third world areas or military situations.

Another use is to microencapsulate fragrances and/or oils with these compressed coins. In this application, these coins would be placed in warm water. As they are expanded they can be used as compresses for aromatherapy or other relaxation therapies.

In accordance with another aspect of the present invention, concentrated soaps can be provided in the compressed coins. The concentrated soaps, as well as other ingredients that may be included, need not be microencapsulated. The non-encapsulated soaps and other ingredients can also be provided in combination with the microencapsulated materials in the compressed coins. The compressed coins can be, by way of example only, any shape paper or fabric product.

It is believed that there are substantial uses and a substantial business for combining these two technologies. Without the dryness of the microencapsulation it would cause the coins to expand and/or the ingredients to be dissipated.

### DESCRIPTION OF A PREFERRED EMBODIMENT

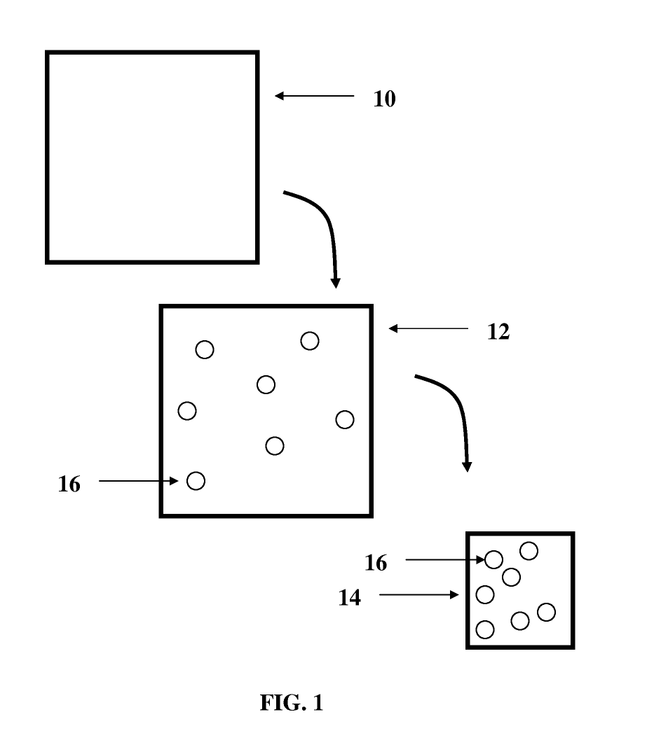

FIG. 1 illustrates one aspect of the present invention. Article 10 is paper, a woven good or cloth. The article 10 can, for example, be made of rayon, but any compressible material can be used.

Microencapsulated beads or materials 16 are added to the article 10 by known techniques to form a new article 12. The microencapsulated beads 16 can be formed to be soluble in a liquid, such as water. In this case, the microencapsulated beads 16 will dissolve upon contact with the liquid and, upon being dissolved, will release the encapsulated material in the beads 16. The microencapsulated beads 16 can also be formed to break upon a pressure or friction being asserted on the beads 16. In this case, the beads 16 will break and release their contents upon the exertion of the pressure.

The article 12 having the microencapsulated beads can be compressed to a smaller size, such as the size of article 14, using any known technique, the techniques including but not limited to dehydration or submitting the article 14 to vacuum pressure. The size of the article 12 is usually small, such as the size of a coin or a button. Other sizes, however, can be used.

The materials in the microencapsulated beads 16 can include an antibiotic, a pharmaceutical, an alcohol, a fragrance, an oil, a skin conditioner, a skin moisturizer, or combinations thereof. Other materials can include cleansers, polishes, anti itch materials and anti-inflammatory materials.

Any number of fragrances can be used. For example, fragrances thought to help calm people can be used. A bubble gum fragrance can also be used to provide a unique bubble bath for children.

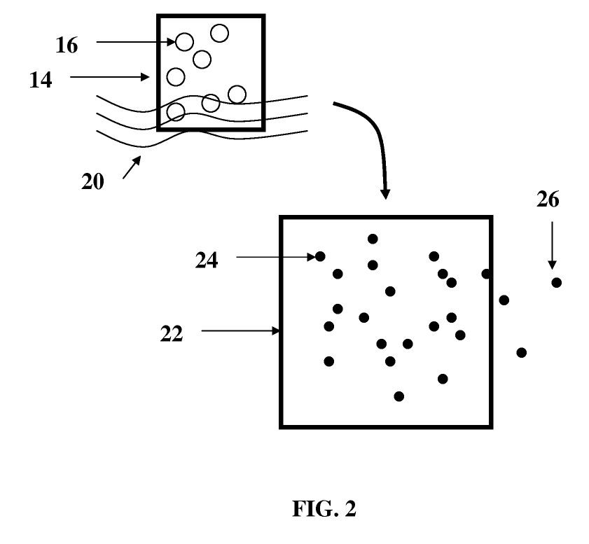

FIG. 2 illustrates the article 14 being exposed to a liquid 20. The liquid 20 can be any liquid that will de-compress the article 14. By way of example, the liquid could be water. The liquid 20, in this case, also preferably dissolves the microencapsulated beads 16 to release the contents of the beads.

The result of the application of liquid 20 is that the article 14 expands to the size of the article 22. The microencapsulated beads 16 have dissolved, releasing the contents 24 and 26. Generally, if the contents of the beads 16 were in liquid form, the contents 24 will stay on the article 22. If the contents of the beads 16 included fragrances, the contents 26 may leave the article 22.

In the case where the microencapsulated beads 16 are broken by friction, the application of the liquid 20 would not dissolve the beads 16. Instead, when the article 22 is rubbed on another article, such as a person's skin, the beads 16 are broken and the contents 24 and 26 are released.

The article 10 can be any compressible material that can be expanded.

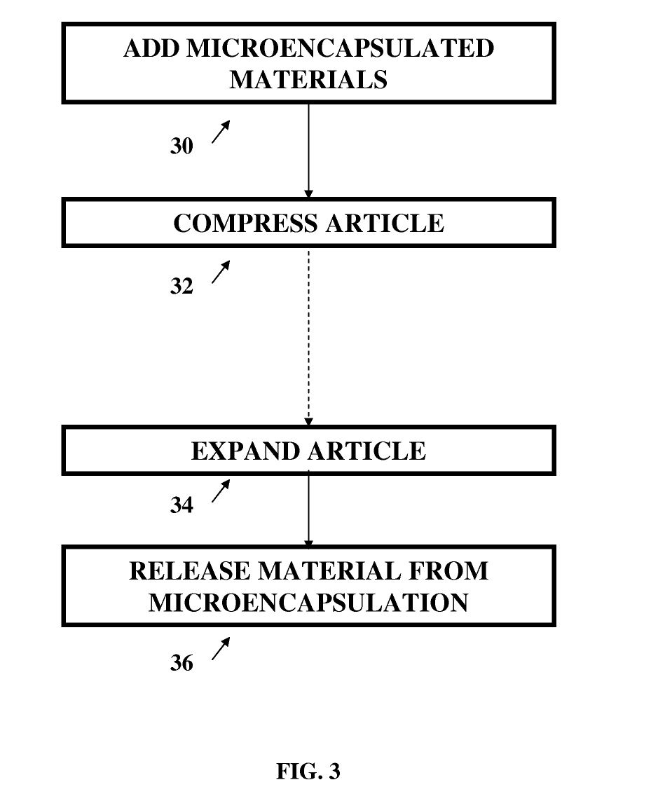

FIG. 3 illustrates a method in accordance with one aspect of the present invention. In step 30, microencapsulated beads are added to an article. As stated before, the article can be cloth, a woven material, paper or any compressible material. In step 32, the article is compressed. The order of these two steps can be reversed.

In step 34, the article is expanded. In step 36, the contents of the microencapsulated beads 16 are released either as a result of contact with a liquid or as a result of friction or pressure.

The articles of the present invention can be used, by way of example only, to treat wounds, to provide therapy, such as aroma therapy or relaxation therapy, for bubble baths, for cleaning—both personal and for objects.

In accordance with another aspect of the present invention, the article 10 that is compressed can also be shaped. The article 10 can also have printed material on it. The shape of the article 10 and the printed material preferably have a relation to the article 10 and the material released by the microencapsulated beads 16. For example, if the article 10 is a wash cloth and the microencapsulated material is a bubble gum fragrance so that a child might enjoy a bath, the article 10 can be shaped like a cartoon character and a picture of the carton character can be printed on the article 10. For example, the article 10 could be shaped like Mickey Mouse™ and a picture of Mickey Mouse™ could be placed on the article 10.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

A further aspect of article 10 of the invention includes selecting as a substrate for the compressible article a material that expands to a larger size when it is contacted by water. Suitable materials include, but are not limited to, natural sponge, polyurethane sponge, cellulose sponge, paper or paper that includes fibrous materials, woven fabric and non-woven fabric. Suitable woven fabrics may be made from natural fibers such as cotton or linen, synthetic fibers such as polyamide, polyester, viscose and combinations of natural and synthetic fibers. Suitable non-woven fabrics include spun, adhesive or otherwise bonded polyolefin, polyester and polyamide fibers. These materials, when compressed in a substantially dry state and then placed in an aqueous environment absorb water and expand to a larger size. Additionally, for particular applications, article 10 may include non-encapsulated ingredients, such as soap, concentrated soap and other ingredients. The article 10 may include a surface active agent that may be soap or other ingredients. The surface active agent selected may include a soap, including a natural soap such as sodium stearate, preferably in the form of flakes or shavings and the like, but other forms also may be used and are within the scope of the present invention. A synthetic surface active agent such as sulfonated linear and branched hydrocarbons, alpha olefins or alklated aromatics and compatible salts thereof are also suitable for the article of the invention. Amine oxide and polyether alcohol surface active agents, either individually or in compatible combination with other surface active agents may also be preferred for particular applications. Additionally, fragrance materials and dyes or colorants, and foam enhancing agents such as diethanolamides and the like may be incorporated into article 10 of the present invention. For particular applications, it may be preferred to select surface active agents having antimicrobial activity or to include antimicrobial agents either admixed with the surface active agents or as microencapsulants as described above. Suitable antimicrobial agents include, but are not limited to, quaternary ammonium salts, biguanides, halogenated phenols and the like. When the surface active agent and the antimicrobial agents are selected, care should be taken to ensure that the materials selected are compatible with each other and with the substrate materials. These materials may or may not be encapsulated. Thus, the beads 16 in FIG. 2 can be encapsulated or non-encapsulated. Further, the non-encapsulated materials can be provided on the compressible material (ie the coin) in combination with microencapsulated materials.

A method for making compressed article 10 that is expandable to a larger size upon contact with water includes selecting a compressible material. In accordance with one aspect of the present invention, the material can be selected from the group consisting of natural sponge, synthetic sponge, woven fabric and non-woven fabric. The selected material can be optionally formed into a preselected shape. Suitable methods for forming the material include, but are not limited to, cutting, shearing, tearing and the like. The method of the invention further includes applying a preselected amount of a suitable non-encapsulated material to the compressible material. The non-encapsulated material can be a surface active agent, with or without other additives as described above, that is applied to the compressible substrate. The method then includes reducing the physical size of the compressible substrate by application of sufficient mechanical force to compress the substrate material. This compression may also be facilitated by conducting the compression at a temperature above room temperature but below a decomposition point for the selected materials and/or under an atmosphere of pressure below that of ambient atmospheric pressure and/or substantial absence of moisture. Depending on the material, the compression can also be accomplished by applying a vacuum.

In addition to compressing the material, for some applications, the method may include the compressed material being wrapped with a packaging material to retain the compressed size. Suitable wrapping materials may include a metallic foil wrap, a paper wrapper, a polymeric film wrap, a heat shrinkable wrapper and a wrap formed from combinations of these materials. Depending on the materials selected for the substrate and the additives, it may be preferred that the wrapping materials substantially prevent atmospheric moisture transmission to the packaged article.

In order to use compressed article 10 of the invention, a user would unwrap the article from the package and allow it to become wet with water, whereupon the compressed article would absorb water and substantially return to its uncompressed size and shape. In the preferred instance where article 10 includes a surface active agent, the user would then be able to generate a foam or lather, by rubbing the article on a surface with water for cleaning and the like.

A particular benefit of article 10 of the invention would be to provide dense well-packaged cleaning articles that could be readily stored because they are compressed and include surface active agents.

The non-encapsulated materials that are added to the compressed material can include the previously mentioned soaps as well as other ingredients. For example, non-encapsulated fragrances, medicines, antibacterial agents, antiviral agents and the like can be provided on the compressible material.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

What is claimed:

1. An article comprising:
a compressed paper, sponge or fabric that is expandable upon contact with water; and
a concentrated soap.

2. The article of claim 1, wherein the soap is in the form of a flake or shaving.

3. The article of claim 2, wherein the soap comprises sodium stearate.

4. The article of claim 1, wherein the soap is a surface active agent.

5. The article of claim 4, wherein the surface active agent comprises a synthetic surface active agent selected from the group consisting of sulfonated linear and branched hydrocarbons, sulfonated alpha olefins, alklated aromatic sulfonates, compatible salts thereof, amine oxides and polyether alcohols, either individually or in compatible combinations thereof.

6. The article of claim 1, wherein the material for forming the compressed paper or fabric is selected from the group consisting of natural sponge, polyurethane sponge, cellulose sponge, paper or paper that includes fibrous materials, woven fabric and non-woven fabric.

7. The article of claim 5, wherein the woven fabrics comprise natural fibers selected from the group cotton or linen.

8. The article of claim 5, wherein the woven fabrics comprise synthetic fibers selected from the group consisting of polyamide, polyester, viscose and combinations of thereof.

9. The article of claim 5, wherein the woven fabrics comprise natural fibers, synthetic fibers and combinations of natural and synthetic fibers.

10. The article of claim 5, wherein the non-woven fabrics are selected from the group consisting of spun-bonded or adhesive-bonded polyolefin fibers, polyester fibers, polyamide fibers and combinations thereof.

11. The article of claim 1, wherein the surface active agent comprises a germicidal agent.

12. The article of claim 10, wherein the germicidal agent is selected from the group consisting of germicidal surface active agents, biguanides, halogenated phenolics, and quaternary ammonium salts.

13. The article of claim 11, wherein the germicidal agent is microencapsulated.

14. The article of claim 11, wherein the germicidal agent is admixed with a compatible surface active agent.

15. The article of claim 1 being placed in a package formed from a material selected from the group consisting of paper, metallic foil, polymeric film and combinations thereof.

16. The article of claim 14, wherein the package material comprises a heat-shrinkable polymeric film having been exposed to sufficient conditions to heat shrink and thereby to substantially maintain the article in the compressed form until the package is opened.

17. The article of claim 1, wherein the paper, sponge or fabric comprises a towel, a face cloth, or a wiping article.

18. A method for making a compressed article expandable to a larger size by contact with water comprises:
selecting a compressible substrate from the group consisting of natural sponge, synthetic sponge, woven fabric and non-woven fabric;
forming the compressible substrate into a preselected size and shape;
applying a preselected amount of a surface active agent to the compressible substrate; and
reducing the size of the compressible substrate by applying mechanical pressure.

19. The method of claim 17 further comprising at least one of the conditions selected from the group consisting of:
applying the compressive force at a temperature above room temperature and below a decomposition temperature of the materials selected;
applying the compressive force while maintaining the article at a pressure below atmospheric pressure; and
applying the compressive force while maintaining the article in a substantially moisture free environment.

20. The method of claim 18, further comprising placing the compressed article in a package formed from a material selected from the group consisting of paper, polymeric film, metallic foil and combinations thereof.
